(19) United States
(12) Patent Application Publication
(10) Pub. No.: US 2026/0196047 A1
(43) Pub. Date: Jul. 9, 2026

(54) DETERMINATION OF RELEVANT SEGMENTS OF MEDIA CONTENT FROM EVENTS

(71) Applicant: International Business Machines Corporation, Armonk, NY (US)

(72) Inventors: Zachary Augustus Silverstein, Georgetown, TX (US); SUMAN PATRA, Kolkata (IN); Logan Bailey, Atlanta, GA (US); Jeremy R. Fox, Georgetown, TX (US)

(21) Appl. No.: 19/009,122

(22) Filed: Jan. 3, 2025

(51) Int. Cl. G06V 20/40; G06T 11/00; G06V 10/82; G06V 30/19

(52) U.S. Cl. CPC G06V 20/49; G06T 11/00; G06V 10/82; G06V 20/44; G06V 30/19

(57) ABSTRACT

Segmentation of personalized content from media content of events includes retrieving media content associated with an event. In data including a set of attributes associated with a user is retrieved. The user is one of an active participant of the event or a passive participant of the event. A machine learning (ML) model is applied to the input data and the media content. Additionally, a segment of the media content correlated with the set of attributes is determined. At least one an alert or the segment is rendered on a user device associated with the user.

### BACKGROUND

The disclosure relates to personalizing content and more particularly, to the determination of relevant segments of media content from events.

In the modern environment, various events such as team meetings play a key role in enabling collaborative efforts and informed decision-making processes in various organizations. Generally, the events often cover a broad spectrum of topics, including discussions that may be irrelevant for some participants. The variability in content relevance can create challenges for users such as active participants (e.g., the users present in the events) seeking specific information about the events or passive participants (e.g., the users absent in the meeting) seeking insights into the events.

### SUMMARY

In various embodiments of the disclosure, a computer-implemented method for determination of relevant segments of media content from events. The computer-implemented method includes retrieving, by a computer, media content associated with an event. The computer-implemented method further includes retrieving, by the computer, first input data including a first set of attributes associated with a first user of a set of users. The first user is one of an active participant of the event or a passive participant of the event. The computer-implemented method further includes applying, by the computer, a first machine learning (ML) model on the media content and the first input data. The computer-implemented method further includes determining, by the computer, a segment of the media content based on the application of the first ML model on the media content and the first input data. The segment is correlated with the first set of attributes. The computer-implemented method further includes rendering, by the computer, at least one of an alert or the segment on a first user device associated with the first user. The alert is associated with the segment.

In various embodiments of the disclosure, a computer system is described. The computer system includes a processor set, one or more computer-readable storage media, and program instructions stored on the one or more computer-readable storage media. The program instructions executable by the processor set to cause the processor set to perform a method for determination of relevant segments of media content from events. The program instructions further cause the processor set to retrieve media content associated with an event. The program instructions further cause the processor set to retrieve first input data that includes a first set of attributes associated with a first user of a set of users. The first user is one of an active participant of the event or a passive participant of the event. The program instructions further cause the processor set to apply a first machine learning (ML) model on the media content and the first input data. The program instructions further cause the processor set to generate a similarity score between the media content and the first input data based on the application of the first ML model on the media content and the first input data. The program instructions further cause the processor set to determine the similarity score is greater than a threshold score. The program instructions further cause the processor set to determine a segment of the media content based on the determination that the similarity score is greater than the threshold score. The segment is correlated with the first set of attributes. The program instructions further cause the processor set to render at least one of an alert or the segment on a first user device associated with the first user. The alert is associated with the segment.

In various embodiments of the disclosure, a computer-program product is described. The computer-program product includes one or more computer-readable storage media and program instructions stored on the one or more computer-readable storage media to perform operations for determination of relevant segments of media content from events. The operations include retrieving the media content associated with an event. The operations further include retrieving first input data including a first set of attributes associated with a first user of a set of users. The first user is one of an active participant of the event or a passive participant of the event. The operations further include applying a first machine learning (ML) model on the media content and the first input data. The operations further include determining a segment of the media content based on the application of the first ML model on the media content and the first input data. The segment is correlated with the first set of attributes. The operations further include rendering at least one of an alert or the segment on a first user device associated with the first user. The alert is associated with the segment.

Additional technical features and benefits are realized through the various processes of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for the determination of relevant segments of media content from events, in accordance with an embodiment of the disclosure;

FIG. 2 is a diagram that illustrates an environment for the determination of relevant segments of media content from events, in accordance with an embodiment of the disclosure;

FIG. 3 is a diagram that illustrates exemplary operations for the determination of relevant segments of media content from events, in accordance with an embodiment of the disclosure;

FIG. 4 is a diagram that illustrates an exemplary user interface (UI) for rendering alerts generated in association with the determination of relevant segments of media content from events, in accordance with an embodiment of the disclosure;

FIG. 5 is a diagram that illustrates exemplary UI for rendering relevant segments of media content from events, in accordance with an embodiment of the disclosure; and

FIG. 6 is a diagram that illustrates a flowchart of an exemplary method for determination of relevant segments of media content from events, in accordance with an embodiment of the disclosure.

### DETAILED DESCRIPTION

In the present scenario, various events such as team meetings are tools required for communication and collaboration within organizations and are often in different formats such as in-person (also referred to as offline) and virtual (also referred to as online) setups. In traditional offline events, users (also referred to as participants) gather in a shared physical space and engage in direct interactions. Alternatively, online events are conducted via digital platforms and enable the users to connect from different locations. This flexibility has become increasingly valuable, especially in the present scenario where remote and hybrid work arrangements are common among the users. Generally, the users either participate in the events (e.g., meetings such as all-hands meetings, open discussions, product demonstrations, academic conferences, and business conferences) or go through recorded sessions of the events. Often the events are characterized by varying relevance of content and can sometimes extend to longer durations, thereby, posing a challenge for the users participating in the events and for the users that are revisiting specific information related to the event. Additionally, for the events with varying relevance, the users go through irrelevant and additional information related to the events that lead to inefficiencies and additional time consumption, thereby impacting the overall experience for the users and retention of different aspects of the events. Further, during or after the events, the users can have queries regarding specific aspects of the events and are required to search across multiple sources such as online resources or internal documentation of the organizations to obtain solutions for the queries. This process can be cumbersome, time-consuming, and inefficient, further degrading the overall experience for the users.

Conventional systems can record the events utilizing camera sensors, microphones, screen recording tools, or additional recording technologies, and provide the users with both video recordings of the events and transcripts of the events to go through information discussed during the events. Further, the conventional system provides the users with search functionality to retrieve relevant information to the users from the video recordings or the transcripts. However, the search functionality typically required precise keywords that the user could be unaware of to retrieve the relevant information, thereby making it challenging for the users. The conventional system further provides configurable speed settings to the users to access the video recordings which can lead to reduced comprehension of the information discussed during the event.

To address these issues, a system that can perform the determination of relevant segments of media content (e.g., audio content, video content, and textual content) from events is disclosed. Such a system leverages machine learning models and natural language processing to generate a user profile associated with a user based on input data received from the user or the social profiles associated with the user. Further, the system determines a segment of the media content based on the user profile. The segment of the media content may be relevant content to the user. Based on the determination of the segment of the media content, the system notifies the user about the segment of the media content or provides a summary of the event. Additionally, the system responds to any queries associated with the segment of the media content, thus enhancing the user experience by enabling efficient access to relevant information and minimizing the time required for the user to acquire solutions to the queries.

The disclosed system utilizes machine learning algorithms to identify personalized content (e.g., the segment) for the user from the media content associated with the event. The disclosed system stores the media content. Further, the disclosed system identifies engagement patterns associated with the user based on the input data. The engagement patterns correspond to the interaction preferences of the user with the media content such as the preferred subject area. The disclosed system further processes the media content and the engagement patterns to dynamically adjust the determination of the segment based on the engagement patterns. Based on the determination of the segment of the media content, the system notifies the user about the segment of the media content or provides a summary of the event. Additionally, the disclosed system receives feedback associated with the rendering of at least one of the alerts associated with the segment or the segment on the first user device. Based on the feedback, the disclosed system continuously improves and refines the identification of the engagement patterns and the determination of the segment. This data-driven adaptability of the disclosed system ensures scalability and efficient segment determination of the media content relevant to the user, thereby ensuring precise segment retrieval and personalized alert or segment delivery. Additionally, the disclosed system offers various customization options to the user for improved identification of the personalized content that allows for precise alerts aligned with evolving user preferences.

The disclosed system extracts content in real-time without the need for training, thereby allowing for immediate identification of the personalized content for the user. Thus, the disclosed system can be deployed to enable seamless integration into existing platforms (such as online meeting platforms) with minimal setup requirements. The disclosed system can further operate as a standalone solution or can be implemented as a plugin within the existing platforms, thereby providing flexible integration options. Additionally, the disclosed system stores the media content in a timeline-based manner, that allows for efficient indexing and retrieval of the segment of the media content that is relevant to the user. This results in faster identification of the segment and reduced processing time of the disclosed system.

In various embodiments of the disclosure, a computer-implemented method for determination of relevant segments of media content from events. The computer-implemented method includes retrieving, by a computer, media content associated with an event. The computer-implemented method further includes retrieving, by the computer, the first input data including a first set of attributes associated with a first user of a set of users. The first user is one of an active participant of the event or a passive participant of the event. The computer-implemented method further includes applying, by the computer, a first machine learning (ML) model on the media content and the first input data. The computer-implemented method further includes determining, by the computer, a segment of the media content based on the application of the first ML model on the media content and the first input data. The segment is correlated with the first set of attributes. The computer-implemented method further includes rendering, by the computer, at least one of an alert or the segment on a first user device associated with the first user. The alert is associated with the segment.

In various embodiments of the disclosure, the computer-implemented method further includes generating, by the computer, a similarity score between the media content and the first input data based on the application of the first ML model on the media content and the first input data. The computer-implemented method further includes determining, by the computer, the similarity score is greater than a threshold score. The computer-implemented method further includes determining, by the computer, the segment of the media content based on the determination that the similarity score is greater than the threshold score.

In various embodiments of the disclosure, the computer-implemented method further includes retrieving, by the computer, engagement data associated with the first user and the event. The engagement data is indicative of an active participation of the first user in the event. The computer-implemented method further includes identifying, by the computer, a presence of an ongoing association of the first user with the event based on the retrieval of the engagement data. The computer-implemented method further includes determining, by the computer, the first user corresponds to the active participant of the event based on the identification of the presence of the ongoing association. The computer-implemented method further includes generating, by the computer, the alert to notify the first user. The alert is generated based on the determination that the first user corresponds to the active participant of the event and the determination of the segment. The computer-implemented method further includes rendering, by the computer, the alert on the first user device.

In various embodiments of the disclosure, the alert corresponds to at least one of a text message, a voice message, haptic feedback, a push notification, or a pop-up message.

In various embodiments of the disclosure, the computer-implemented method further includes retrieving, by the computer, engagement data associated with the first user and the event. The engagement data is indicative of a passive participation of the first user in the event. The computer-implemented method further includes identifying, by the computer, an absence of an ongoing association of the first user with the event based on the retrieval of the engagement data. The computer-implemented method further includes determining, by the computer, the first user corresponds to the passive participant of the event based on the identification of the absence of the ongoing association and the determination of the segment. The computer-implemented method further includes rendering, by the computer, the segment on the first user device based on the determination that the first user corresponds to the passive participant of the event.

In various embodiments of the disclosure, the computer-implemented method further includes applying, by the computer, a second ML model on the first input data. The computer-implemented method further includes classifying, by the computer, the first user into a set of categories based on the application of the second ML model on the first input data. The computer-implemented method further includes generating, by the computer, a first user profile associated with the first user based on the first input data and the set of categories. The computer-implemented method further includes applying, by the computer, the first ML model on the media content and the first user profile. The computer-implemented method further includes determining, by the computer, the segment of the media content based on the application of the first ML model on the media content and the first user profile.

In various embodiments of the disclosure, the computer-implemented method further includes receiving, by the computer, a query associated with the segment of the media content. The query is received from the first user device. The computer-implemented method further includes obtaining, by the computer, a solution associated with the query from at least one of a second user device or one or more sources. The second user device is associated with a second user of the set of users. The computer-implemented method further includes rendering, by the computer, the solution on the first user device.

In various embodiments of the disclosure, the computer-implemented method further includes retrieving, by the computer, second input data including a second set of attributes associated with the second user. The second user is associated with the first user. The computer-implemented method further includes applying, by the computer, the second ML model on the second input data. The computer-implemented method further includes classifying, by the computer, the second user into the set of categories based on the application of the second ML model on the second input data. The computer-implemented method further includes generating, by the computer, a second user profile based on the second input data and the set of categories. The second user profile is associated with the second user.

In various embodiments of the disclosure, the computer-implemented method further includes identifying, by the computer, an association of the second user profile with the query based on the reception of the query. The computer-implemented method further includes rendering, by the computer, the query on the second user device based on the identification of the association of the second user profile with the query. The computer-implemented method further includes obtaining, by the computer, the solution from the second user device based on the rendering of the query on the second user device. The computer-implemented method further includes rendering, by the computer, the obtained solution on the first user device.

In various embodiments of the disclosure, the computer-implemented method further includes receiving, by the computer, feedback associated with the determination of the segment of the media content. The computer-implemented method further includes training, by the computer, the first ML model based on the received feedback.

In various embodiments of the disclosure, the media content is in at least one of an audio format, a video format, or a textual format.

In various embodiments of the disclosure, the computer-implemented method further includes applying, by the computer, a speech recognition process on the media content. The computer-implemented method further includes determining, by the computer, a first set of parameters based on the application of the speech recognition process. The first set of parameters corresponds to textual data associated with the media content. The computer-implemented method further includes storing, by the computer, the first set of parameters associated with the media content. The first set of parameters is stored in a sequence of occurrence during the event. The computer-implemented method further includes applying, by the computer, the first ML model on the first set of parameters and the first input data. The computer-implemented method further includes determining, by the computer, the segment of the media content based on the application of the first ML model on the first set of parameters and the first input data.

In various embodiments of the disclosure, the computer-implemented method further includes applying, by the computer, at least one of an optical character recognition process or a neural net ingestion process on the media content. The computer-implemented method further includes determining, by the computer, a second set of parameters based on the application of at least one of the optical character recognition process or the neural net ingestion process. The second set of parameters corresponds to at least one of textual data associated with the media content, audio data associated with the media content, or video data associated with the media content. The computer-implemented method further includes storing, by the computer, the second set of parameters associated with the media content. The second set of parameters is stored in a sequence of occurrence during the event. The computer-implemented method further includes applying, by the computer, the first ML model on the second set of parameters and the first input data. The computer-implemented method further includes determining, by the computer, the segment of the media content based on the application of the first ML model on the second set of parameters and the first input data.

In various embodiments of the disclosure, the first set of attributes includes at least one of activity data associated with the first user, assignment data associated with the first user, social media data associated with the first user, historical contribution data associated with the first user, expertise area data associated with the first user, field-of-interest data associated with the first user, behavior data associated with the first user, work pattern data associated with the first user, or feedback data associated with the first user.

In various embodiments of the disclosure, the computer-implemented method further includes monitoring, by the computer, an interaction of the first user with the segment of the media content. The computer-implemented method further includes calculating, by the computer, a completion score of the segment based on the monitoring of the interaction. The completion score is indicative of completion of the interaction of the first user with the segment. The computer-implemented method further includes rendering, by the computer, the completion score on the first user device.

In various embodiments of the disclosure, a computer system is described. The computer system includes a processor set, one or more computer-readable storage media, and program instructions stored on the one or more computer-readable storage media. The program instructions executable by the processor set to cause the processor set to perform a method for determination of relevant segments of media content from events. The program instructions further cause the processor set to retrieve media content associated with an event. The program instructions further cause the processor set to retrieve first input data that includes a first set of attributes associated with a first user of a set of users. The first user is one of an active participant of the event or a passive participant of the event. The program instructions further cause the processor set to apply a first machine learning (ML) model on the media content and the first input data. The program instructions further cause the processor set to generate a similarity score between the media content and the first input data based on the application of the first ML model on the media content and the first input data. The program instructions further cause the processor set to determine the similarity score is greater than a threshold score. The program instructions further cause the processor set to determine a segment of the media content based on the determination that the similarity score is greater than the threshold score. The segment is correlated with the first set of attributes. The program instructions further cause the processor set to render at least one of an alert or the segment on a first user device associated with the first user. The alert is associated with the segment.

In various embodiments of the disclosure, the program instructions further cause the processor set to retrieve engagement data associated with the first user and the event. The engagement data is indicative of an active participation of the first user in the event. The program instructions further cause the processor set to identify a presence of an ongoing association of the first user with the event based on the retrieval of the engagement data. The program instructions further cause the processor set to determine the first user corresponds to the active participant of the event based on the identification of the presence of the ongoing association. The program instructions further cause the processor set to generate the alert to notify the first user. The alert is generated based on the determination that the first user corresponds to the active participant of the event and the determination of the segment. The program instructions further cause the processor set to render the alert on the first user device.

In various embodiments of the disclosure, the program instructions further cause the processor set to retrieve engagement data associated with the first user and the event. The engagement data is indicative of a passive participation of the first user in the event. The program instructions further cause the processor set to identify an absence of an ongoing association of the first user with the event based on the retrieval of the engagement data. The program instructions further cause the processor set to determine the first user corresponds to the passive participant of the event based on the identification of the absence of the ongoing association and the determination of the segment. The program instructions further cause the processor set to render the segment on the first user device based on the determination that the first user corresponds to the passive participant of the event.

In various embodiments of the disclosure, the program instructions further cause the processor set to receive feedback associated with the determination of the segment of the media content. The program instructions further cause the processor set to train the first ML model based on the received feedback.

In various embodiments of the disclosure, a computer-program product is described. The computer-program product includes one or more computer-readable storage media and program instructions stored on the one or more computer-readable storage media to perform operations for determination of relevant segments of media content from events. The operations include retrieving the media content associated with an event. The operations further include retrieving first input data including a first set of attributes associated with a first user of a set of users. The first user is one of an active participant of the event or a passive participant of the event. The operations further include applying a first machine learning (ML) model on the media content and the first input data. The operations further include determining a segment of the media content based on the application of the first ML model on the media content and the first input data. The segment is correlated with the first set of attributes. The operations further include rendering at least one of an alert or the segment on a first user device associated with the first user. The alert is associated with the segment.

Additional technical features and benefits are realized through the various processes of the disclosure. Embodiments and aspects of the disclosure are described in detail herein and are considered a part of the claimed subject matter. For a better understanding, refer to the detailed description and to the drawings.

Various aspects of the disclosure are described by narrative text, flowcharts, block diagrams of computer systems and/or block diagrams of the machine logic included in computer-program product (CPP) embodiments. With respect to any flowcharts, depending upon the technology involved, the operations can be performed in a different order than what is shown in a given flowchart. For example, again depending upon the technology involved, two operations shown in successive flowchart blocks could be performed in reverse order, as a single integrated operation, concurrently, or in a manner at least partially overlapping in time.

A computer-program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium could be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or additional freely propagating electromagnetic waves, electromagnetic waves propagating through a waveguide, light pulses passing through a fiber optic cable, electrical signals communicated through a wire, and/or additional transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

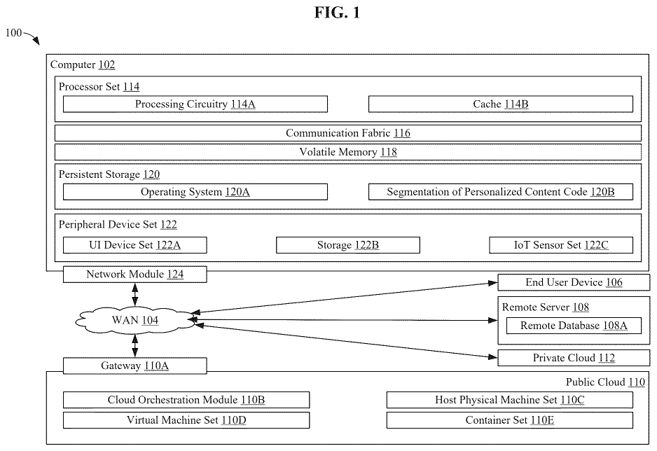

FIG. 1 is a diagram that illustrates a computing environment for determination of relevant segments of media content from events, in accordance with an embodiment of the disclosure. With reference to FIG. 1, there is shown a computing environment 100 that contains an example of an environment for the execution of at least some of the computer code involved in performing the disclosed methods, such as segmentation of personalized content code 120B. In addition to the segmentation of personalized content code 120B, the computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the segmentation of personalized content code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or additional wearable computer, a mainframe computer, a quantum computer, or any form of a computer or a mobile device now known or to be developed in the future that is configured for running a program, accessing a network or querying a database, such as the remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, even though it is not shown in a cloud in FIG. 1. In an alternate embodiment, the computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the additional storage media discussed below. The program instructions, and associated data, are accessed by the processor set 114 to control and direct the performance of the disclosed methods. In the computing environment 100, at least some of the instructions for performing the disclosed methods may be stored in the dynamic modification of the segmentation of personalized content code 120B in the persistent storage 120.

The communication fabric 116 is the signal conduction path that allows the various components of the computer 102 to intercommunicate. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the segmentation of personalized content code 120B typically includes at least some of the computer code involved in performing the disclosed methods.

The peripheral device set 122 includes the set of peripheral devices of the computer 102. Data communication connections between the peripheral devices and the additional components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen 214, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where the computer 102 is required to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows the computer 102 to communicate with one or more computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is any wide area network (for example, the internet) configured for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through WAN 104 to EUD 106. In this way, the EUD 106 can display, or alternatively present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by the one or more computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or additional computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer-program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in various embodiments of the disclosure, the private cloud 112 may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

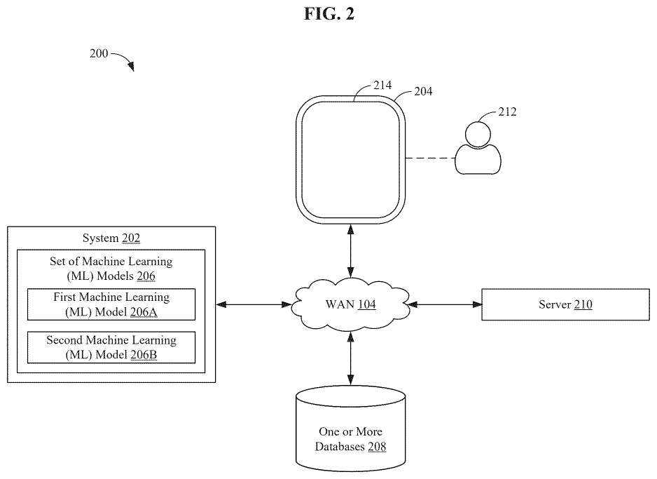

FIG. 2 is a diagram that illustrates an environment for the determination of relevant segments of media content from events, in accordance with an embodiment of the disclosure. FIG. 2 is explained in conjunction with elements from FIG. 1. With reference to FIG. 2, there is shown a diagram of a network environment 200. The network environment 200 includes a system 202, and a first user device 204. The system 202 includes a set of machine learning (ML) models 206. The network environment 200 further includes one or more databases 208, a server 210, and a first user 212 associated with the first user device 204. The network environment 200 further includes the WAN 104 of FIG. 1. In an embodiment of the disclosure, the system 202 may be an exemplary embodiment of the computer 102 of FIG. 1.

The system 202 may include suitable logic, circuitry, interfaces, and/or code that may be configured for the segmentation of personalized content from media content of events. The system 202 may be configured to retrieve first media content associated with an event. The first media content associated with the event may include audio recordings, video streams, transcripts, presentations, and additional relevant textual materials that may include discussions, performances, or activities that took place during the event. Additionally, the system 202 accesses live feeds or archived media associated with the event. Based on the accessed live feeds or the archived media, the system 202 retrieves the first media content associated with the event. In an embodiment, the event may correspond to various activities such as a meeting, conference, sports event, seminar, or any form of gathering where information is exchanged.

The system 202 may be configured to retrieve first input data including a first set of attributes associated with the first user 212 of a set of users. The first set of attributes may include a comprehensive collection of data points that provide detailed information about the first user 212. By way of example, and not by limitation, the first set of attributes may include at least one of activity data associated with the first user 212, assignment data associated with the first user 212, social media data associated with the first user 212, historical contribution data associated with the first user 212, expertise area data associated with the first user 212, field-of-interest data associated with the first user 212, behavior data associated with the first user 212, work pattern data associated with the first user 212, feedback data associated with the first user 212, and the like.

In an embodiment, the activity data associated with the first user 212 may include records of events or activities in which the first user 212 may have participated, such as meetings attended or workshops completed, indicating active involvement in professional development for the first user 212. The assignment data associated with the first user 212 may include specific tasks or projects assigned to the first user 212 within their organization. The social media data associated with the first user 212 may include the interaction of the first user 212 on various platforms social media platforms. For example, the first user 212 may regularly share articles about emerging technologies or participate in discussions on a technology (say machine learning), indicating interests and areas of influence in the field of technology.

The historical contribution data associated with the first user 212 may include records of the past contributions of the first user 212 within their organization such as ideas proposed by the first user, solutions implemented by the first user 212, and the like. The expertise area data associated with the first user 212 may include information about specific fields or domains in which the first user 212 may possess knowledge or skills. Examples of the expertise area associated with the first user 212 may include software development, data analytics, or marketing strategy.

The field-of-interest data associated with the first user 212 may include information about topics or domains that the first user 212 shows interest in exploring or engaging with. For example, the first user 212 may frequently engage with articles on artificial intelligence, sustainable development, or graphic design. The behavior data associated with the first user 212 may include insights about the working style or preferences of the first user 212. Examples of the behavior data associated with the first user 212 may include, how the first user 212 interacts and communicates with their colleagues, and how the first user 212 responds to work deadlines.

The work pattern data associated with the first user 212 may include information about the working habits and schedules of the first user 212 within their organization. Examples of the work pattern data may include peak productivity hours, frequency of breaks, trends in task completion, and the like. The feedback data associated with the first user 212 may include information provided by the user in response to previously generated segments of past events. Examples of the feedback data may include suggestions, comments, or ratings for improvement.

The first user 212 may be one of an active participant of the event or a passive participant of the event. In an embodiment, the active participant may engage in the event in real-time, contributing to discussions and activities. For example, the first user 212 may be an active participant in an ongoing meeting (e.g. the event) to discuss updates in company policy for a company associated with the first user 212. Alternatively, the passive participant may correspond to a user who may not be able to attend the event and may later engage with the recording or transcripts of the event. For example, the first user 212 may not be actively participating in the ongoing meeting (e.g. meeting related to updates in company policy) and may go through a recorded session of the meeting and thus become the passive participant.

The system 202 may be further configured to provide the first media content and the first input data, as an input, to a first machine learning (ML) model 206A of the set of ML models 206. Further, the system 202 may be configured to determine a first segment of the first media content based on the application of the first ML model 206A on the first media content and the first input data. For example, the ML model may identify the first segment of the media content by correlating the first set of attributes with the media content. The system 202 may be further configured to render at least one of an alert or the first segment on the first user device 204. The alert may be associated with the first segment.

The first user device 204 may include suitable logic, circuitry, interfaces, and/or code that may be configured to receive the first input data from the first user 212. The first user device 204 may be further configured to transmit the first input data to the system 202. The first user device 204 may include a display screen 214. In an embodiment, at least one of the alerts or the first segment may be rendered on the display screen 214. Examples of the first user device 204 may include, but are not limited to, a smartphone, a cellular phone, a mobile phone, a smart watch, a computing device, or the like.

The display screen 214 may include suitable logic, circuitry, and interfaces that may be configured to render at least one of the alert or the first segment. In an embodiment of the disclosure, the display screen 214 may be a touch screen which may enable the first user 212 to provide the first input data via the display screen 214. The touch screen may be at least one of a resistive touch screen, a capacitive touch screen, or a thermal touch screen. In accordance with an embodiment of the disclosure, the display screen 214 may refer to a display screen 214 of a head-mounted device (HMD), a smart-glass device, a see-through display, a projection-based display, an electro-chromic display, or a transparent display. In some embodiments of the disclosure, the display screen 214 may be realized through several known technologies such as, but are not limited to, at least one of a Liquid Crystal Display (LCD) display, a Light Emitting Diode (LED) display, a plasma display, or an Organic LED (OLED) display technology, or additional display devices.

The first ML model 206A may be a computational network or a system of artificial neurons, arranged in a plurality of layers, as nodes. The plurality of layers of the first ML model 206A may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in one or more layers of the first ML model 206A. Outputs of each hidden layer may be coupled to inputs of at least one node in one or more layers of the first ML model 206A. Node(s) in the final layer may receive inputs from at least one hidden layer to output a result. The number of layers and the number of nodes in each layer may be determined from hyper-parameters of the first ML model 206A. Such hyper-parameters may be set before or while training the first ML model 206A on a training dataset.

Each node of the first ML model 206A may correspond to a mathematical function (e.g., a sigmoid function or a rectified linear unit) with a set of parameters, tunable during the training of the network. The set of parameters may include, for example, a weight parameter, a regularization parameter, and the like. Each node may use the mathematical function to compute an output based on one or more inputs from nodes in one or more layers (e.g., previous layer(s)) of the first ML model 206A. All or some of the nodes of the first ML model 206A may correspond to the same or a different mathematical function.

During the training of the first ML model 206A, one or more parameters of each node of the first ML model 206A may be updated based on whether an output of the final layer for a given input (from the training dataset) matches a correct result based on a loss function for the first ML model 206A. The above process may be repeated for the same or a different input until a minimum of loss function may be achieved, and a training error may be minimized. Several methods for training are known in the art, for example, gradient descent, stochastic gradient descent, batch gradient descent, gradient boost, meta-heuristics, and the like.

The first ML model 206A may include electronic data, such as, for example, a software program, code of the software program, libraries, applications, scripts, or additional logic or instructions for execution by a processing device, such as the processor set 114. The first ML model 206A may include code and routines configured to enable a computing device, such as the system 202, to perform one or more operations. Additionally, or alternatively, the first ML model 206A may be implemented using hardware including a processor, a microprocessor (e.g., to perform or control the performance of one or more operations), a field-programmable gate array (FPGA), or an application-specific integrated circuit (ASIC). Alternatively, in some embodiments, the first ML model 206A may be implemented using a combination of hardware and software. Although in FIG. 2, the first ML model 206A is shown as a separate entity from the system 202, the disclosure is not so limited. Accordingly, in some embodiments, the first ML model 206A may be integrated within the system 202, without deviation from the scope of the disclosure. In an embodiment, the first ML model 206A may be stored in the server 210. Examples of the first ML model 206A may include, but are not limited to, a deep neural network (DNN), a convolutional neural network (CNN), a CNN-recurrent neural network (CNN-RNN), an artificial neural network (ANN), a fully connected neural network, and/or a combination of such networks.

In additional embodiments, the first ML model 206A may be a sophisticated piece of software that leverages natural language processing (NLP) and machine learning processes to understand, generate, and manipulate human language. For example, the first ML model 206A may correspond to a language model or a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. For example, the LLM model for language processing may be implemented using GPT, Bidirectional Encoder Representations from Transformers (BERT), and the like.

Further, the LLM may be a type of ML model specifically designed to understand, generate, and manipulate human language on a large scale. LLMs may leverage machine learning processes, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training. In an embodiment, the first ML model 206A may be used to analyze the first media content to identify a specific segment that correlates with the first set of attributes associated with the first user 212. Thus, the first ML model 206A focuses on determining the segments, enabling the system 202 to isolate meaning information (e.g., the first segment) specific to the first user 212.

In an embodiment, a second ML model 206B of the set of ML models 206 may correspond to a computer-based system or software that employs a supervised or unsupervised machine learning process to analyze the first input data. Based on the analysis of the first input data, the first user 212 may be classified into a set of categories. The classification may be based on one of the supervised ML process or unsupervised ML process to evaluate various attributes, such as user demographics, behavioral patterns, and interaction history. By applying advanced classification algorithms (e.g., Support Vector Machines, Random Forest, K-Means Clustering, and the like), the second ML model 206B may effectively classify the first user 212 into at least one category of the set of categories. For example, when the first input data may indicate that the first user 212 frequently engages in collaborative projects and has a strong background in software development, the second ML model 206B may classify the first user 212 as a collaborative developer. Alternatively, when the first user 212 engages in design-related tasks and has provided feedback indicating a preference for creative projects, the first user 212 may be categorized as a creative contributor.

The one or more databases 208 may correspond to an organized collection of data that may be stored and accessed electronically from a computer system (such as the system 202). In an embodiment, the one or more databases 208 may store the first input data. In an embodiment, the one or more databases 208 may be configured to receive the first input data from the first user device 204. The one or more databases 208 may be further configured to store the first media content. For example, the one or more databases 208 may store recordings associated with the first media content. The one or more databases 208 may be designed to manage, store, retrieve, and update the user data efficiently. The structure of the one or more databases 208 typically involves tables, records, and fields that can be managed through various database management systems (DBMS). Examples of the one or more databases 208 may include, but are not limited to, a relational database, a Non-Structured Query Language (NoSQL) database, a hierarchical database, a network database, a transactional database, a data warehouse, a distributed database, or the like.

The server 210 may include suitable logic, circuitry, and interfaces, and/or code that may be configured to receive the first input data from the first user device 204. Upon receiving the first input data, the server 210 may be further configured to store the first input data. In an embodiment, the server 210 may be configured to store the first ML model 206A and the second ML model 206B. The server 210 may be implemented as a cloud server and may execute operations through web applications, cloud applications, HTTP requests, repository operations, file transfer, and the like. Additional example implementations of the server 210 may include, but are not limited to, a database server, a file server, a web server, a media server, an application server, a mainframe server, or a cloud computing server.

In an embodiment of the disclosure, the server 210 may be implemented as a plurality of distributed cloud-based resources by use of several technologies that are well known to those ordinarily skilled in the art. A person with ordinary skill in the art will understand that the scope of the disclosure may not be limited to the implementation of the server 210 and the system 202 as two separate entities. In certain embodiments, the functionalities of the server 210 can be incorporated in its entirety or at least partially in the system 202, without a departure from the scope of the disclosure.

In operation, the system 202 may be configured to retrieve the first media content associated with the event. In an embodiment, the system 202 may correspond to a physical computer that may be installed at a venue of the event (e.g., a meeting or a conference) such that the system 202 may directly retrieve the first media content (e.g., audio, visual, or textual content) through various means, including cameras, microphones, and additional sensory devices. In additional embodiments, the system 202 may retrieve the first media content indirectly through networked connections to external sources that may provide audio-visual feeds or textual data related to the event. For example, when a meeting is ongoing, the system 202 may access a live stream or recorded media from remote participants or additional third-party platforms to retrieve the first media content associated with the meeting.

The system 202 may be further configured to retrieve the first input data including the first set of attributes associated with the first user 212. In an embodiment, the first input data may be retrieved from the first user device 204. For example, the system 202 may have prompted the first user 212 to retrieve locally stored information on the first user device 204. Further, the first user 212 may have granted access to the system 202 to retrieve the locally stored information on the first user device 204 such as app usage patterns, browsing history, calendar events, and the like. In an alternate embodiment, the system 202 may retrieve the first input data from one or more external sources that may be associated with the first user 212. The first input data may correspond to publicly available data such as activity logs, connections, affiliation, interests, and the like. Examples of the one or more external sources may include, but are not limited to, social media platforms, and professional networking sites.

The system 202 may be further configured to apply the first ML model 206A on the first media content and the first input data. In an embodiment, the first ML model 206A may be pre-trained on a large dataset to identify correlations between different media content and input data associated with one or more users. For example, the first ML model 206A may be pre-trained using supervised learning techniques on the large dataset that includes labeled examples of different media content and corresponding input data. The system 202 may be configured to determine the first segment of the first media content based on the application of the first ML model 206A on the first media content and the first input data. The first segment may be correlated with the first set of attributes. The system 202 may be further configured to render at least one of the alert (the alert associated with the first segment) or the first segment on the first user device 204 associated with the first user 212. Examples of the alert may include a text message, a voice message, haptic feedback, a push notification, a pop-up message, and the like.

In an embodiment, when the first user 212 may correspond to the active participant, the system 202 may render the alert associated with the first segment on the first user device 204, thereby ensuring that the first user 212 is aware of critical discussion or updates (e.g., the first segment) as they occur. The alert may correspond to at least one of a text message, a voice message, haptic feedback, a push notification, or a pop-up message. For example, the alert associated with the first segment may correspond to visual notifications (the text message, the push notification, or the pop-up message) that appear on the first user device 204 to provide timely updates or prompt actions required during the event (e.g., the meeting). For example, the alert may be rendered on the first user device 204 to notify the first user 212 about the relevant segment (e.g., the first segment) in the event, thereby ensuring awareness and active participation for the relevant segment. Additionally, the alert associated with the first segment may correspond to haptic alerts (haptic feedback), such as vibrations on the first user device 204 to deliver notifications without disrupting the flow of the event. Further, the alert associated with the first segment may correspond to audio alerts (the voice message) rendered on the first user device 204.

In additional embodiments, when the first user 212 may correspond to the passive participant, the system 202 may render the first segment on the first user device 204, thereby ensuring that the first user 212 can access critical discussion or updates from the event that may be relevant to the first user 212. For example, the system 202 may render the first segment (e.g., the summary of the relevant content for the first user 212) of the event after the event concluded on the first user device 204. The system may leverage the WAN 104 or an API to deliver the first segment on the first user device 204. The first segment may be rendered (delivered) via email or through a messaging application to enable the first user 212 (the passive user) to catch up on missed content (the first media content) of the event.

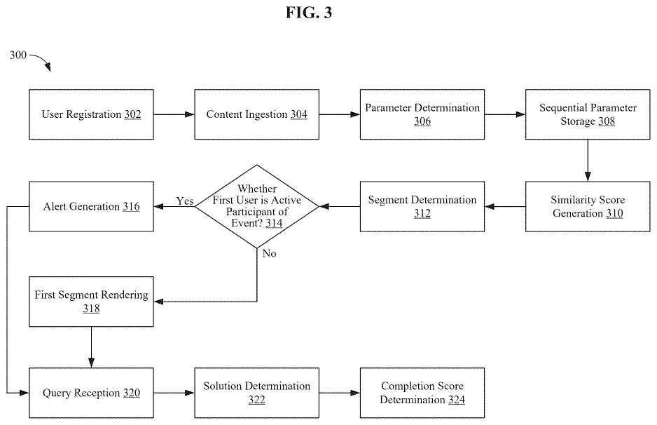

FIG. 3 is a diagram that illustrates exemplary operations for the determination of relevant segments of media content from events, in accordance with an embodiment of the disclosure. FIG. 3 is explained in conjunction with elements from FIG. 1, and FIG. 2. With reference to FIG. 3, there is shown a block diagram 300 that illustrates exemplary operations from 302 to 326, as described herein. The exemplary operations illustrated in the block diagram 300 may start at 302 and may be performed by any computing system, apparatus, or device, such as by the computer 102 of FIG. 1 or system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a user registration operation may be executed. In an embodiment, in the user registration operation, the system 202 may be configured to receive the first input data associated with the first user 212. The first user 212 may either correspond to a member associated with an organization or an individual who may engage or participate in one or more events, either actively or passively. Details about active participation and passive participation are explained later in the description.

The first input data may include the first set of attributes associated with the first user 212. The first set of attributes may include at least one of activity data associated with the first user 212, assignment data associated with the first user 212, social media data associated with the first user 212, historical contribution data associated with the first user 212, expertise area data associated with the first user 212, field-of-interest data associated with the first user 212, behavior data associated with the first user 212, work pattern data associated with the first user 212, feedback data associated with the first user 212, and the like.

The system 202 may be further configured to apply the second ML model 206B on the first input data. Based on the application of the second ML model 206B on the first input data, the system 202 may be further configured to classify the first user 212 into a set of categories. By way of example, and not by limitation, the set of categories may include expert contributor, occasional participant, passive observer, and the like. In an embodiment, the system 202 may classify the first user 212 as an expert contributor while the first user 212 may frequently share in-depth knowledge and insights during the event (e.g., meeting), demonstrating an advanced proficiency in specific technical fields. The advanced proficiency may refer to a deep understanding of specific technical fields, characterized by the ability to provide accurate, in-depth, and contextually relevant knowledge. Further, the system 202 may classify the first user 212 as an occasional participant when the first user 212 may exhibit limited engagement during the event, such as contributing primarily to a specific topic of interest while refraining from active or consistent participation across all discussions or interactions during the event.

In an embodiment, the system 202 may implement a multi-class classifier that may identify an area of expertise of the first user 212 based on the past contributions associated with the first user 212 and the educational background of the first user 212. The multi-class classifier may be trained based on a list of relevant expertise areas specific to an organization associated with the first user 212. Furthermore, the system 202 may enhance the classification by pretraining a statistical language model and subsequently fine-tuning the statistical language model to improve accuracy in identifying the user expertise of the first user 212.

The system 202 may be further configured to apply the second ML model 206B on the first input data to generate a first user profile based on the first input data and the set of categories. By way of example, and not by limitation, the system 202 may integrate various data sources to generate the first user profile. For example, the first user profile may be constructed based on personal information associated with the first user 212, historical contributions associated with the first user 212, and behavioral patterns associated with the first user 212 observed during historical discussions. The first user profile may be specific to the first user 212 and may aggregate the first input data. Additionally, the first user profile may aggregate behavioral patterns, and individual needs into a comprehensive profile. In an embodiment, the first input data may be manually entered by the first user 212 through the first user device 204. For example, the first user 212 may enter the first input data by means of a chatbot, registration form, or a questionnaire. Additionally, the system 202 may be further configured to access external data sources associated with the first user 212 upon receiving permission and consent from the first user 212. In an embodiment, the external data sources may correspond to social media platforms associated with the first user 212.

In an embodiment, the system 202 may be further configured to analyze behavioral patterns related to one or more events (e.g., meetings or discussions) that the first user 212 may actively participate in. The behavioral patterns may be analyzed based on feedback related to the one or more events or actively monitoring real-time or near real-time conversations of the one or more events. The system 202 may further update the first user profile based on the analyzed behavioral patterns. By way of example, and not by limitation, the one or more events may be categorized by attributes such as type (e.g., urgent, formal, informal, and analytical), setting (e.g., all-hands meeting, open discussions, product demonstrations, academic conference or business conference), duration, and participant composition (e.g., total number of active participants, portion of time each participant spends speaking, and the like). In an embodiment, the system 202 may be further configured to analyze metadata (e.g., agenda, description, transcripts, and the like) associated with the one or more events to categorize the one or more events.

The system 202 may leverage aggregate statistics associated with the attributes to identify trends in participation preferences of the first user 212 to improve the categorization of users (e.g., the first user 212 and the second user), thereby improving the accuracy of the system 202. In an embodiment, the aggregate statistics may correspond to summarized or combined data points that may be collected over time from multiple interactions involving the first user 212 (and other users). The aggregate statistics may be derived from patterns such as frequency of participation in different types of event, or duration of active involvement of the first user 212. For example, when the first user 212 may prefer to participate more actively in analytical discussions within small groups, the system 202 may identify a pattern by monitoring conversations associated with the first user 212 indicating the preference of the first user 212 for a structured and collaborative environment. Further, the system 202 may refine the first user profile based on the identified patterns. In an embodiment, the one or more databases 208 may store the first user profile and the details (e.g., the first input data) associated with the first user 212 such that the system 202 may retrieve the first user profile and the details (e.g., the first input data) associated with the first user 212 during determination of the first segment of the media content.

At 304, a content ingestion operation may be executed. In the content ingestion operation, the system 202 may be configured to retrieve the first media content associated with the event. The event may correspond to interaction involving the exchange of information among participants, and may be facilitated through various mediums such as audio, video, text, or shared visual data. The first media content may be in at least one of an audio format, a video format, or a textual format. For example, when the event may correspond to a meeting, the first media content may correspond to audio recordings, video streams, transcripts, presentations, and additional relevant textual materials that may include discussions, performances, or activities that took place during the event.

In an embodiment, the event may occur in a physical environment, virtual environment, or hybrid (e.g., a combination of physical and virtual) environment and may include various activities such as a meeting, conference, sports event, seminar, and the like. The first media content associated with the event may include audio recordings, video streams, transcripts, presentations, and additional relevant textual materials that may include discussions, performances, or activities that took place during the event. Additionally, the system 202 may be configured to access the live feeds or the archived media associated with the event. Based on the accessed live feeds or the archived media, the system 202 may be further configured to retrieve the first media content associated with the event. In an embodiment, the content ingestion operation may occur at any point following the user registration operation that may establish a base layer of user-specific information and the details (e.g., the first input data) associated with the first user 212. In an alternate embodiment, the content ingestion operation may occur independently or even before the user registration operation, depending on the sequence of user activity. For example, the first user 212 may join the event as a guest or without completing the user registration operation. In this case, the system 202 may still execute the content ingestion operation, and later, once the first user completes the user registration operation, the system 202 may proceed with operations from 306 to 326 steps.

The system 202 may interface with a set of electronic devices deployed at the event such as microphones for capturing audio, cameras for recording visual data, and computing devices for managing text inputs allowing for real-time or near-real-time data capture. For example, when the event may correspond to a corporate meeting scenario, the set of electronic devices deployed at the event may correspond to microphones, cameras, and the like. Such that the microphones can capture audio from discussions and presentations from the event. Additionally, visual data (e.g., gestures, facial expressions, live interactions, and the like) can be recorded by the cameras that may be used to document the meeting for future reference ensuring that the first media content is preserved.

In an alternate embodiment, when the system 202 may interface with user devices associated with attendees of the event, the system 202 may be configured to prompt attendees (e.g., the set of users) to provide access to cameras, microphones, and screen-sharing features on respective user devices. In an additional embodiment, the system 202 may correspond to a virtual participant of the event, thereby enabling the system 202 to retrieve the media content associated with the event. For example, when the event corresponds to a video conference, the system 202 may join as the virtual participant, thereby receiving live audio from the microphone, visual data from the camera, text data from chat interactions, and the like.

In yet additional embodiment, the system 202 may retrieve the media content associated with the event from a server that hosts the event such that the media content may be stored and made accessible post-event or during the event. In yet additional embodiment, the system 202 may retrieve the media content associated with the event from cloud-based services or third-party applications integrated with a platform that hosts the event such as social media feeds, collaborative document platform, or project management tools that may include notes or shared files during the event. In yet additional embodiment, the system 202 may retrieve the media content associated with the event from multiple sources in real-time or near real-time, including third-party application programming interfaces (APIs), event management platforms, and enterprise collaboration systems.

At 306, a parameter determination operation may be executed. In an embodiment, in the parameter determination operation, the system 202 may be configured to apply a speech recognition process on the first media content retrieved during the content ingestion operation when the first media content may be in the audio format. The system 202 may be further configured to determine a first set of parameters based on the application of the speech recognition process. The speech recognition process may refer to a method by which the system 202 may analyze audio content from the event to convert spoken language into human-readable text (e.g., the first set of parameters). In an embodiment, the system 202 may transcribe speech, identify key phrases, extract relevant information such as the identity of the speaker or the sentiment of the speaker, and convert it into readable text. Thus, the system 202 facilitates the rapid conversion of discussions, presentations, and additional verbal communications into readable text that can be easily processed and stored for further operations.

Although it is mentioned that the system 202 may apply the speech recognition process on the first media content, in various embodiments, the system 202 may apply deep neural networks or additional processes on the first media content such as NLP, acoustic modeling, noise cancellation, context-aware algorithms, and the like to enhance recognition accuracy and handle diverse speech patterns, accents, and multiple languages from the first media content. Thus, the first set of parameters is determined from the speech recognition process to convert spoken language into text and understand the tone (e.g., positive or neutral) of various conversations during the event.

In additional embodiments, the system 202 may be configured to apply at least one of an optical character recognition (OCR) process or a neural net ingestion process on the first media content when the first media content may be in the textual format or video format that includes textual data. The system 202 may be further configured to determine a second set of parameters based on the application of at least one of the OCR process or the neural net ingestion process. The OCR process may refer to a method by which the system 202 may analyze image or video content including textual data from the event to extract the textual data (e.g., characters or words). This involves identifying and extracting the textual data from visual representations such as scanned documents, screenshots, or video frames, using pattern recognition algorithms and pre-trained models to accurately interpret and extract the text. The neural net ingestion process may refer to a method by which the system 202 may analyze image, video content, or audio content from the event. In this process, the system 202 may use pre-trained or custom neural networks to process complex inputs, such as images, audio, or video, to identify patterns, classify objects, or extract features (e.g., facial expressions, logos, scene transition, and the like).

In an embodiment, the second set of parameters may correspond to a superset of the first set of parameters such that the second set of parameters may include at least one of the textual data associated with the first media content, audio data associated with the first media content, or video data associated with the first media content. For example, the system 202 may apply the OCR process to extract textual data from the images that include text, thereby facilitating the extraction of textual information from scanned documents, photographs, or video frames. Alternatively, the system 202 may apply the neural net ingestion process to analyze both audio and video data associated with the first media content. The first set of parameters, determined by the speech recognition process may correspond to transcriptions, speaker identification, sentiment analysis, and similar audio-based metrics. Alternatively, the second set of parameters, determined by at least one of the OCR process or the neural net ingestion process may correspond to extracted textual data, a description of visual elements from the event, an emotional analysis of the event, and the like.

At 308, a sequential parameter storage operation may be executed. In the sequential parameter storage operation, the system 202 may be configured to store the first set of parameters associated with the first media content. The first set of parameters may be stored in a sequence of occurrence of each parameter of the first set of parameters during the event such that the first set of parameters is in chronological order. Thus, the system 202 ensures that the first set of parameters maintains a chronological record that can be referenced for various purposes, such as analysis, playback, or further processing.

Additionally, the system 202 may be further configured to store the second set of parameters associated with the first media content that may be determined during the parameter determination operation. The second set of parameters may be stored in a sequence of occurrence of each parameter of the second set of parameters during the event such that the second set of parameters is in chronological order. Thus, the system 202 ensures that the second set of parameters maintains a chronological record that can be referenced for various purposes, such as analysis, playback, or further processing. For example, when the event may correspond to a conference meeting, the first set of parameters and the second set of parameters may include timestamps for the contribution of each speaker during the conference meeting. In an embodiment, based on the storage of the first set of parameters and the second set of parameters, the system 202 may accurately reference and retrieve contextually relevant data from the first set of parameters and the second set of parameters during subsequent processing stages that may require contextual understanding of the spoken content.

The system 202 may be further configured to retrieve the first input data including the first set of attributes associated with the first user 212. The first user 212 may be one of the active participants of the event or the passive participant of the event. The system 202 may retrieve the first input data from the one or more databases 208. In an embodiment, when the first user 212 may correspond to the active participant of the event, the system 202 may retrieve the first input data prior to the content ingestion process. In an alternate embodiment, when the first user 212 may correspond to the passive participant of the event, the system 202 may retrieve the first input when the first user 212 intends to access the recording of the event.

At 310, a similarity score generation operation may be executed. In the similarity score generation operation, the system 202 may be configured to generate a similarity score between the first media content and the first input data based on the application of the first ML model 206A on the first media content and the first input data. The first media content (e.g., the first set of parameters and the second set of parameters) may be stored during the sequential parameter storage operation. Alternatively, the system 202 may generate the similarity score between the first media content and the first user profile. In an embodiment, the system 202 may use various processes such as NLP or semantic similarity algorithms to analyze various features extracted from the first media content and the first user profile, such as textual attributes, contextual relevance, and semantic meaning. For example, when the first media content corresponds to a research paper on artificial intelligence, the system 202 may evaluate keywords, topics, and writing style to determine how closely the first media content may align with previous contributions or interests of the first user 212 in artificial intelligence-related discussions. Details about the various processes to analyze various features extracted from the first media content and the first user profile are omitted for the sake of brevity and are known in the art.

At 312, a segment determination operation may be executed. In the segment determination operation, the system 202 may be configured to determine that the similarity score, which may be determined during the similarity score generation operation, may be greater than a threshold score. In an embodiment, the threshold score may correspond to a benchmark to determine whether the first media content may be sufficiently relevant for further engagement with the first user 212. For example, when the threshold is set at 0.75 on a scale of 0 to 1, the system 202 may determine the similarity score for the first five minutes of the first media content as 0.5, indicating a lower relevance to the first user 212. Further, the system 202 may determine the similarity score as 0.8 for the next ten minutes, indicating a higher relevance during this duration. Finally, the system 202 may determine the similarity score as below 0.5 after the first fifteen minutes, indicating the lower relevance to the first user 212. Thus, based on the similarity score exceeding the threshold, the system 202 may determine the first segment as the ten-minute duration of the first media content following the initial five minutes.

The system 202 may be further configured to determine the first segment of the first media content based on the application of the first ML model 206A on the first media content and the first input data. The determination of the first segment may be initiated based on the determination that the similarity score may be greater than the threshold score. The first segment may be correlated with the first set of attributes. In additional embodiments, the system 202 may offer various customization options to the first user 212 for improved determination of the first segment, thus aligning with evolving user preference. For example, the first user 212 may set preferences for specific topics in the event such as product updates or market trends. Thus, the system 202 may determine the first segment of the first media content that matches the preferences set by the first user 212.

At 314, it may be determined whether the first user 212 may be the active participant of the event. In an embodiment, the first user 212 may correspond to one of the active participant of the event or the passive participant of the event. The system 202 may be further configured to determine whether the first user 212 may be an active participant in the event. The active participant may correspond to a user who may engage in the event in real time, contributing to discussions and activities. For example, the first user 212 may correspond to the active participant of the event when the first user 212 may be present (physically or virtually) in an ongoing meeting (e.g. the event) to discuss updates in the company policy for the company associated with the first user 212. Alternatively, the passive participant may correspond to a user who may not be able to attend the event and may later engage with the recording or transcripts of the event. For example, the first user 212 may correspond to the passive participant of the event when the first user 212 may be absent from the meeting (e.g. meeting related to updates in the company policy) and may go through a recorded session of the meeting.

In an embodiment, based on the determination of the first segment, the system 202 may be configured to retrieve engagement data associated with the first user 212 and the event. The engagement data may be indicative of the active participation of the first user 212 in the event. Examples of the engagement data may correspond to attendance data associated with the event, poll or survey of participants, chat contributions, screen activity, and the like. The system 202 may be further configured to identify the presence of an ongoing association of the first user 212 with the event based on the retrieval of the engagement data. The system 202 may be further configured to determine that the first user 212 may correspond to the active participant of the event based on the identification of the presence of the ongoing association. In an embodiment, the presence of the ongoing association may be identified based on the attendance records of the first user 212, locations of the first user 212 and the event, behavioral analytics of the first user 212, and the like. For example, the system 202 may be further configured to retrieve first location data associated with a first location of the first user 212 and a second location associated with a second location of the event. In an embodiment, the system 202 may retrieve the first location data from the first user device 204. Further, the system 202 may retrieve the second location data from one or more devices that may be available at the venue of the event. Further, the system 202 may identify that the first location is within a threshold distance of the second location, when the event may be conducted as an in-person event (e.g., an offline event), thereby indicating the presence of the ongoing association of the first user 212 with the event. Additionally, the system 202 may be further configured to receive attendance data associated with the event when the event may be conducted as a virtual event (e.g., an online event). Based on the attendance data, the system 202 may identify the presence of the ongoing association of the first user 212 with the event.

In additional embodiments, based on the determination of the first segment, the system 202 may retrieve the engagement data associated with the first user 212 and the event. The engagement data may be indicative of the passive participation of the first user 212 in the event. The system 202 may be further configured to identify an absence of the ongoing association of the first user 212 with the event based on the retrieval of the engagement data. The system 202 may be further configured to determine that the first user 212 may correspond to the passive participant of the event based on the identification of the absence of the ongoing association. The absence of the ongoing association may be identified based on the attendance records of the first user 212, the location of the first user 212 and the event, behavioral analytics of the first user 212, and the like. For example, the system 202 may be further configured to retrieve the first location associated with the first user 212 and the second location associated with the event. Further, the system 202 may identify that the first location is not within the threshold distance of the second location, thereby indicating the absence of the ongoing association of the first user 212 with the event. Additionally, the system 202 may be further configured to receive attendance data associated with the event. Based on the attendance data, the system 202 may identify the absence of the ongoing association of the first user 212 with the event. In case the first user 212 may correspond to the active participant of the event, then the control may be transferred to 316. Alternatively, in case the first user 212 may not correspond to the active participant of the event, then the control may be transferred to 318.

At 316, an alert generation operation may be executed. In the alert generation operation the system 202 may be configured to generate the alert to notify the first user 212 about the first segment. The system 202 may generate the alert based on the determination that the first user 212 may correspond to the active participant of the event. The system 202 may be further configured to render the alert on the first user device 204 associated with the first user 212. For example, the alert associated with the first segment may correspond to visual notifications that appear on the first user device 204 to provide timely updates, or prompt actions required during the event (e.g., the meeting). Additionally, the alert associated with the first segment may correspond to haptic alerts, such as vibrations on the first user device 204 to deliver notifications without disrupting the flow of the event and notifying the first user 212 about the relevant segment (e.g., the first segment) in the event, thereby ensuring awareness and active participation of the first user 212 for the relevant segment without disturbing other participants of the event. Further, the alert associated with the first segment may correspond to audio alerts rendered on the first user device 204.

At 318, a first segment rendering operation may be executed. In the first segment rendering operation, the system 202 may be configured to render the first segment on the first user device 204. The system 202 may render the first segment based on the determination that the first user 212 may not correspond to the active participant of the event. Specifically, the system 202 may render the first segment based on the determination that the first user 212 may correspond to the passive participant of the event. For example, the system 202 may render the summary of the event after the event concluded on the first user device 204. The summary may be rendered (delivered) via email or through a messaging application to enable the first user 212 (the passive user) to catch up on missed content (the first media content) of the event.

In an embodiment, the system 202 may render the first segment on the first user device 204 in a back-and-forth driven manner such that the first user 212 may engage in an interactive dialogue with the system 202. For example, after rendering the first segment (e.g., a key highlight from the event), the system 202 may prompt the first user 212 on the first user device 204 with questions such as, “What did you think about this topic?” or “Would you like to explore more about this topic?” Further, the first user 212 may respond directly through quick reply options to provide feedback to the system 202 based on the rendered first segment. The system 202 may be further configured to receive the feedback from the first user 212 via the first user device 204. Further, the system 202 may be configured to train the first ML model 206A based on the received feedback. In an embodiment, the system 202 may be configured to apply the trained first ML model 206A on the first segment and the first input data (or the first user profile) to determine a second segment of the first media content. The second segment may correspond to the first segment which may be updated or adjusted based on the feedback. The system 202 may be further configured to render the second segment on the first user device 204. In an embodiment, updating or adjusting the first segment may correspond to one of adding more content relevant to the first user 212, removing unwanted content that may be not relevant to the first user 212, summarizing content that may be relevant to the first user 212, and the like.

At 320, a query reception operation may be executed. In the query reception operation, the system 202 may be configured to receive a first query associated with the first segment (or the second segment) of the first media content. The first query may be received from the first user 212 via the first user device 204 when the first user 212 may be alerted after the alert generation operation about the first segment of the event that may be relevant to the first user 212. Alternatively, the first query may be received from the first user 212 via the first user device 204 based on the first segment rendering operation. In an embodiment, the first user 212 may correspond to the active participant of the event and may encounter a complex topic presented by a speaker during the event. Further, the first user 212 may provide the first query to the system 202 via the first user device 204 seeking detailed information on the complex topic. For example, when the event corresponds to a virtual meeting, the system 202 may receive the first query through the microphone of the first user device 204. Alternatively, the system 202 may receive the first query through a chat feature integrated into a platform facilitating the virtual meeting. Additionally, the system 202 may receive a video feed from the first user device 204 when cameras are enabled in the virtual meeting. Further, the system 202 may analyze the video feed to detect signs of confusion or uncertainty in the expression of the first user 212 to determine the first query.

In additional embodiments, the first user 212 may correspond to the passive participant of the event and may encounter a complex topic while interacting with the first segment of the event. Further, the first user 212 may provide the first query to the system 202 via the first user device 204 seeking detailed information on the complex topic. For example, when the first segment corresponds to a video summary of topics relevant to the first user 212. While reviewing the first segment (e.g., the video summary), the first user 212 may provide the first query to the system 202 via the first user device 204. Additionally, the system 202 may analyze playback patterns, such as pauses, rewinds, or repeated views of specific aspects of the first segment. Based on the playback patterns, the system 202 may detect parts of the first segment where the first user 212 may experience difficulty in understanding.

At 322, a solution determination operation may be executed. In the solution determination operation, the system 202 may be configured to process the first query received during the query reception operation. The first query may be processed based on the first ML model 206A such that the context associated with the first query may be interpreted. The system 202 may be configured to obtain a first solution associated with the first query from at least one of a second user device associated with a second user of the set of users or one or more sources. The system 202 may be configured to render the obtained first solution on the first user device 204.

In an embodiment, the one or more sources may correspond to internet-based knowledge repositories such as search engines, or relevant databases that may include solutions to similar queries. Additionally, the one or more sources may correspond to internal databases within a secured network, such as an enterprise knowledge management system, that includes solutions to general queries, internal documentation, or recommendations from subject matter experts. Additionally, the system 202 may be further configured to access third-party APIs or external applications configured to provide specialized or domain-specific data such as scientific databases, industry standards repositories, and the like.

The system 202 may be configured to retrieve second input data including a second set of attributes associated with the second user. The second user may be associated with the first user 212. For example, the first user 212, and the second user may correspond to employees of the same organization in the same team. In an embodiment, the second set of attributes may include a comprehensive collection of data points that provide detailed information about the second user. By way of example, and not by limitation, the second set of attributes may include at least one of activity data associated with the second user, assignment data associated with the second user, social media data associated with the second user, historical contribution data associated with the second user, expertise area data associated with the second user, field-of-interest data associated with the second user, behavior data associated with the second user, work pattern data associated with the second user, feedback data associated with the second user, and the like.

The system 202 may be further configured to classify the second user into a set of categories based on the application of the second ML model 206B on the second input data. By way of example, and not by limitation, the set of categories may include expert contributor, occasional participant, passive observer, and the like. In an embodiment, the system 202 may classify the second user as an expert contributor when the second user may frequently share in-depth knowledge and insights during the event (e.g., meeting), demonstrating a high level of expertise in specific areas relevant to the organization. Further, the system 202 may classify the second user as an occasional participant when the second user may engage during the event rarely, and only contributes to specific topics of interest but not consistently participating in every conversation during the event. Additionally, the system 202 may classify the second user as a passive observer when the second user may primarily listen to the information discussed during the event without actively contributing, indicating a preference for observation over participation.

In an embodiment, the system 202 may implement a multi-class classifier that may identify an area of expertise of the second user based on the past contributions associated with the second user and the educational background of the second user. The multi-class classifier may be trained based on a list of relevant expertise areas specific to an organization associated with the second user. Furthermore, the system 202 may enhance the classification by pretraining a statistical language model and subsequently fine-tuning the statistical language model to improve accuracy in identifying the area of expertise of the second user.

The system 202 may be further configured to apply the second ML model 206B on the second input data to generate a second user profile based on the second input data and the set of categories. By way of example, and not by limitation, the system 202 may integrate various data sources to generate the second user profile. For example, the second user profile may be constructed based on personal information associated with the second user, historical contributions associated with the second user, and behavioral patterns associated with the second user observed during historical discussions. In an embodiment, the system 202 may generate a set of user profiles (including the first user profile and the second user profile) associated with the set of users. Based on the reception of the first query, the system 202 may be further configured to traverse through the set of user profiles. The system 202 may be further configured to identify an association of the second user profile with the first query. In an embodiment, the association may be identified based on a correlation or match between the second user profile and the first query. For example, the system 202 may identify the association of the second user profile with the first query when the first query may correspond to recent advancements in deep learning architecture and the second user profile suggests that the second user has a master's degree in deep learning.

The system 202 may be further configured to render the first query to a second user device associated with the second user based on the identification of the association of the second user profile with the first query. In an embodiment, the system 202 may render the first query as an instant message to the second user device. The system 202 may be further configured to obtain the first solution from the second user device based on the rendering of the first query to the second user device. For example, the system 202 may obtain (receive) the first solution as a reply for the instant message (the first query). In various embodiments, when the first user 212 may correspond to the passive participant of the event, the system 202 may initiate a collaboration session such as video conferencing, a shared interface, a collaborative workspace, and the like. The collaborative session may allow the first user 212 and the second user to effectively engage in resolving the query. The collaborative session may include various tools for annotating, commenting, or providing real-time or near-real-time feedback on the first query. Additionally, when the first user 212 and the second user may be engaged in the collaboration session, the system 202 may be further configured to retrieve the second media content associated with the collaboration session. Further, the system 202 may be configured to apply the first ML model 206A on the second media content. Based on the application of the first ML model 206A, the system 202 may be further configured to determine a third segment of the second media content that may be relevant to the first user 212. In an embodiment, the determination of one or more segments for media content associated with different events may occur in an iterative manner for multiple collaboration sessions. Further, the system 202 may store the one or more segments to enable efficient retrieval and review of the prior context of the media content.

Although it is mentioned that the system 202 may render the first query to the second user device associated with the second user, in various embodiments, the system 202 may render the first query to one or more user devices associated with a user of the set of users based on a preference selected by the first user 212. The preference may correspond to a choice or inclination of the first user 212 for engaging in a discussion with a particular user. By way of example, and not by limitation, the first user 212 may select preference to render the first query to a third user device associated with a third user of the set of users instead of the second user device.

At 324, a completion score determination operation may be executed. In the completion score determination operation, the system 202 may be configured to monitor an interaction of the first user 212 with the first segment of the first media content. In an embodiment, the interaction may include a set of engagement metrics such as time spent viewing, playback progression, scrolling behavior, and direct interactions (e.g., clicks, comments, annotations) with the first segment.

The system 202 may be configured to calculate a completion score based on the monitoring of the interaction. In an embodiment, the completion score may be indicative of the extent of the interaction of the first user with the segment. Further, the completion score may be calculated as a percentage representing the portion of the first segment that the first user 212 has engaged with. For example, when the first user 212 has viewed 75% of the total duration of the first segment (e.g., a video summary of the event) or scrolled through 75% of the first segment (e.g., text summary of the event), the completion score may be set to 75%. In additional embodiments, the system 202 may apply weighting factors based on the quality of interaction. For example, when the first user 212 may actively engage by adding annotations, highlighting sections, or replaying portions of the first segment, the system 202 may apply a higher score to reflect intensive interactions.

The system 202 may be further configured to render the completion score on the first user device 204, providing visual feedback to the first user 212 regarding the progress of the interaction. In an embodiment, the completion score may be displayed in real-time or near real-time, updating dynamically as the first user 212 interacts with the first segment. Additionally, the completion score may be displayed in real-time or near real-time, updating dynamically based on the solution determination operation such that the completion score may increase when the first query is resolved. Examples of visual feedback may include progress bars, percentage indicators, milestone markers, and the like. In additional embodiments, the system 202 may be further configured to communicate the completion score to multiple stakeholders such as administrators or collaborators associated with the event. Additionally, the system 202 may provide reminders when the completion score is below a predefined threshold to prompt further interactions of the first user 212 with the first segment.

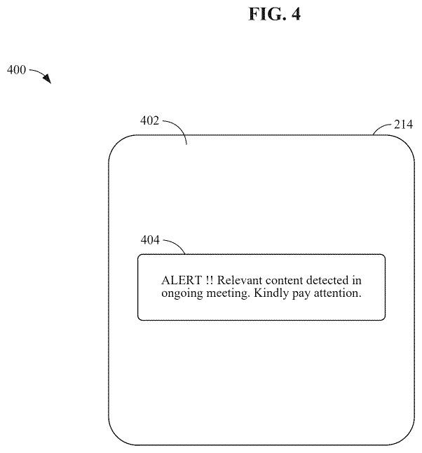

FIG. 4 is a diagram that illustrates an exemplary user interface (UI) for rendering alerts generated in association with the determination of relevant segments of media content from events, in accordance with an embodiment of the disclosure. FIG. 4 is explained in conjunction with elements from FIG. 1, FIG. 2, and FIG. 3. With reference to FIG. 4, there is shown an exemplary diagram 400 that includes an exemplary lockscreen 402 of the display screen 214. The lockscreen 402 may include a UI element 404. The UI element 404 may correspond to an alert for a user (e.g., the first user 212).

In an embodiment, the first user 212 may correspond to the active participant of the event (e.g., meeting or seminar) such that the first user 212 may be attending the event in-person or virtually. The system 202 may retrieve the first media content (e.g., audio data, video data, textual data) associated with the event. Further, the system 202 may retrieve the first input data including the first set of attributes (e.g., historical contribution, assignment data, area of expertise) associated with the first user 212. The system 202 may further apply the first ML model 206A on the first media content and the first input data. Based on the application of the first ML model 206A, the system 202 may determine the first segment of the first media content that may be correlated (or relevant) to the first user 212. The system 202 may further render the alert as the UI element 404 on the lockscreen 402.

In an embodiment, the system 202 may monitor actions of the first user 212 such as mouse clicks, keystrokes, idle time, and the like to determine whether the first user 212 is attentive during the event. For example, when the event corresponds to a virtual meeting, a low frequency of interaction, such as minimal mouse movement or a long period of inactivity may indicate a lack of attention. Further, based on the determination of the first segment and the determination that the first user 212 may not be attentive, the system 202 may render the alert on the first user device 204. As illustrated in FIG. 4, the UI element 404 on the lockscreen 402 may display a prompt stating, “ALERT! ! Relevant content detected in an ongoing meeting. Kindly pay attention.” This instruction may prompt the first user 212 to be more attentive in the ongoing meeting (the event). In an embodiment, the UI element 404 may be customizable based on the preference of the first user 212. For example, the first user 212 may configure the type of alert notification (e.g., pop-up, vibrations, or sound), the timing of alerts, and the like. Additionally, the system 202 may adjust the appearance of the UI element 404 based on the configuration of the first user device 204. For example, the UI element 404 (the alert) may be displayed in a larger font with high contrast when the first user device 204 is in low-light mode. Alternatively, the UI element 404 (the alert) may appear as a floating notification when the first user 212 may be operating the first user device 204. For the sake of brevity, the UI element 404 is only shown to include text, in various embodiments, the UI element 404 may include buttons that may allow the first user 212 to confirm awareness during the event.

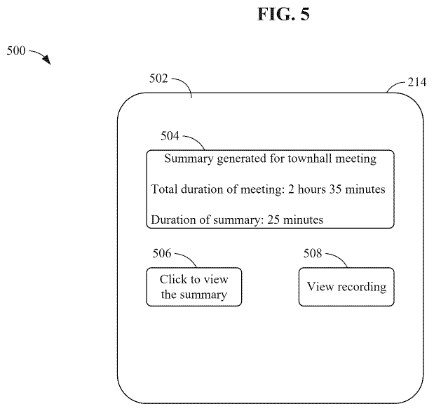

FIG. 5 is a diagram that illustrates exemplary UI for rendering relevant segments of media content from events, in accordance with an embodiment of the disclosure. FIG. 5 is explained in conjunction with elements from FIG. 1, FIG. 2, FIG. 3, and FIG. 4. With reference to FIG. 5, there is shown an exemplary diagram 500 that includes an exemplary home screen 502 of the display screen 214. The home screen 502 may include a first UI element 504, a second UI element 506, and a third UI element 508. The first UI element 504 may correspond to a notification for the user (e.g., the first user 212). The second UI element 506 and the third UI element 508 may correspond to buttons that include selectable options.

In an embodiment, the first user 212 may correspond to the passive participant of the event (e.g., meeting or seminar) such that the first user 212 may be absent during the event. The system 202 may retrieve the first media content (e.g., audio data, video data, textual data) associated with the event. Further, the system 202 may retrieve the first input data including the first set of attributes (e.g., historical contribution, assignment data, area of expertise) associated with the first user 212. The system 202 may further apply the first ML model 206A on the first media content and the first input data. Based on the application of the first ML model 206A, the system 202 may determine the first segment of the first media content that may be correlated (or relevant) to the first user 212. The system 202 may further render the first UI element 504, the second UI element 506, and the third UI element 508 on the home screen 502.

In an embodiment, the event may correspond to a town hall meeting such that the total duration of the town hall meeting was 2 hours and 35 minutes. Further, the system 202 may determine the duration of the first segment of the town hall meeting that may be correlated (relevant) to the first user 212 as 25 minutes. For the sake of brevity, the first segment is referred to as “summary.” As illustrated in FIG. 5, the first UI element 504 may display a prompt stating, “Summary generated for town hall meeting”. The first UI element 504 may further display “Total duration of meeting: 2 hours 35 minutes” and “Duration of summary: 25 minutes”. Further, the second UI element 506 may display a prompt stating “Click to view the summary.” Additionally, the third UI element 508 may display a prompt stating “View recording.”

In an embodiment, the first user 212 may select the second UI element 506 by clicking on it. Based on the selection of the second UI element 506, the system 202 may render the summary (e.g., the first segment) associated with the town hall meeting (e.g., the event). For example, when the town hall meeting includes discussion on departmental budgets, upcoming product launches, or policy changes that may be relevant to the first user 212, the summary may include such portions. In an embodiment, the summary may be presented in various formats depending on the preferences of the first user 212 and the device capabilities of the first user device 204.

In additional embodiments, the first user 212 may select the third UI element 508 by clicking on it. Based on the selection of the third UI element 508, the system 202 may render a full recording of the town hall meeting, with enhancements tailored for the first user 212. For example, the system 202 may render options to skip to the relevant parts of the town hall meetings to allow the first user 212 to skip the additional parts. In various embodiments, the system 202 may provide options to the first user 212 to customize the summary. For example, the first user 212 may specify one or more keywords that may prompt the system 202 to further customize (e.g., filter) the summary to dynamically adjust the summary to include information associated with the one or more keywords.

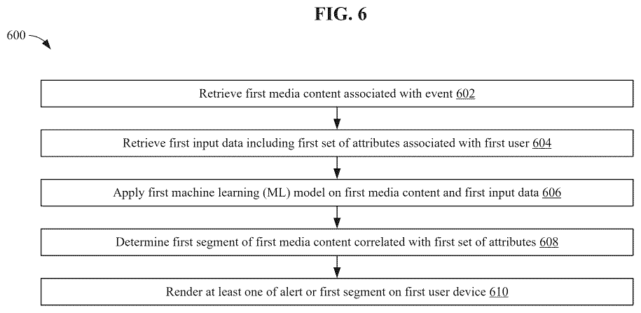

FIG. 6 is a diagram that illustrates a flowchart of an exemplary method for the determination of relevant segments of media content from events, in accordance with an embodiment of the disclosure. FIG. 6 is explained in conjunction with elements from FIG. 1, FIG. 2, FIG. 3, FIG. 4, and FIG. 5. With reference to FIG. 6, there is shown a flowchart 600. The operations of the exemplary method may be executed by any computing system, for example, by the computer 102 of FIG. 1 or the system 202 of FIG. 2. The operations of the flowchart 600 may start at 602.

At 602, the first media content associated with the event is retrieved. In an embodiment of the disclosure, the system 202 may be configured to retrieve the first media content associated with the event. The first media content may be in at least one of the audio formats, the video format, or the textual format. For example, when the event may correspond to a meeting, the first media content may correspond to audio recordings, video streams, transcripts, presentations, and additional relevant textual materials that may include discussions, performances, or activities that took place during the event. Details about the retrieval of the first media content are provided, for example, in FIG. 2, and FIG. 3.

At 604, the first input data including the first set of attributes associated with the first user 212 is retrieved. In an embodiment of the disclosure, the system 202 may be configured to retrieve the first input data including the first set of attributes (e.g., historical contribution, assignment data, area of expertise) associated with the first user 212. The first input data may be retrieved from the first user device 204. For example, the system 202 may access locally stored information on the first user device 204 to which the first user 212 may have granted access such as app usage patterns, browsing history, calendar events, and the like. Alternatively, the first input data may be retrieved from one or more external sources associated with the first user 212 such as social media platforms, professional networking sites, and the like. The system 202 may retrieve the publicly available data or data to which the first user 212 may have granted access such as activity logs, connections, affiliation, interests, and the like. Details about the retrieval of the first input data are provided, for example, in FIG. 2, and FIG. 3.

At 606, the first ML model 206A may be applied on the first media content and the first input data. In an embodiment of the disclosure, the system 202 may be configured to apply the first ML model 206A on the first media content and the first input data. The first ML model 206A may be trained on a large dataset to identify correlations between the first media content and the first input data associated with the first user 212. Details about the application of the first ML model 206A are provided, for example, in FIG. 2, and FIG. 3.

At 608, the first segment of the first media content correlated with the first set of attributes may be determined. In an embodiment of the disclosure, the system 202 may be configured to determine the first segment of the first media content based on the application of the first ML model 206A on the first media content and the first input data. The first segment of the first media content may represent a portion of the first media content based on the preferences of the first user 212. Details about the determination of the first segment are provided, for example, in FIG. 2, and FIG. 3.

At 610, at least one of the alert or the first segment may be rendered on the first user device 204. In an embodiment of the disclosure, the system 202 may be configured to render at least one of the alert or the first segment on the first user device 204. The first user 212 may be one of the active participant of the event or the passive participant of the event. The system 202 may render the alert on the first user device 204 when the first user 212 may correspond to the active participant of the event. Alternatively, the system 202 may render the first segment on the first user device 204 when the first user 212 may correspond to the passive participant of the event. Details about the rendering of at least one of the alert or the first segment are provided, for example, in FIG. 2, and FIG. 3.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable a reader of ordinary skill in the art to understand the embodiments disclosed herein.

What is claimed is:

1. A computer-implemented method, comprising:
retrieving, by a computer, media content associated with an event;
retrieving, by the computer, first input data comprising a first set of attributes associated with a first user of a set of users, wherein the first user is one of an active participant of the event or a passive participant of the event;
applying, by the computer, a first machine learning (ML) model on the media content and the first input data;
determining, by the computer, a segment of the media content based on the application of the first ML model on the media content and the first input data, wherein the segment is correlated with the first set of attributes; and
rendering, by the computer, at least one of an alert or the segment on a first user device associated with the first user, wherein the alert is associated with the segment.

2. The computer-implemented method of claim 1, further comprising:
generating, by the computer, a similarity score between the media content and the first input data based on the application of the first ML model on the media content and the first input data;
determining, by the computer, the similarity score is greater than a threshold score; and
determining, by the computer, the segment of the media content based on the determination that the similarity score is greater than the threshold score.

3. The computer-implemented method of claim 1, further comprising:
retrieving, by the computer, engagement data associated with the first user and the event, wherein the engagement data is indicative of an active participation of the first user in the event;
identifying, by the computer, a presence of an ongoing association of the first user with the event based on the retrieval of the engagement data;
determining, by the computer, the first user corresponds to the active participant of the event based on the identification of the presence of the ongoing association;
generating, by the computer, the alert to notify the first user, wherein the alert is generated based on the determination that the first user corresponds to the active participant of the event and the determination of the segment; and
rendering, by the computer, the generated alert on the first user device.

4. The computer-implemented method of claim 3, wherein the alert corresponds to at least one of a text message, a voice message, haptic feedback, a push notification, or a pop-up message.

5. The computer-implemented method of claim 1, further comprising:
retrieving, by the computer, engagement data associated with the first user and the event, wherein the engagement data is indicative of a passive participation of the first user in the event;
identifying, by the computer, an absence of an ongoing association of the first user with the event based on the retrieval of the engagement data;
determining, by the computer, the first user corresponds to the passive participant of the event based on the identification of the absence of the ongoing association and the determination of the segment; and
rendering, by the computer, the segment on the first user device based on the determination that the first user corresponds to the passive participant of the event.

6. The computer-implemented method of claim 1, further comprising:
applying, by the computer, a second ML model on the first input data;
classifying, by the computer, the first user into a set of categories based on the application of the second ML model on the first input data;
generating, by the computer, a first user profile associated with the first user based on the first input data and the set of categories;
applying, by the computer, the first ML model on the media content and the first user profile; and
determining, by the computer, the segment of the media content based on the application of the first ML model on the media content and the first user profile.

7. The computer-implemented method of claim 6, further comprising:
receiving, by the computer, a query associated with the segment of the media content, wherein the query is received from the first user device;
obtaining, by the computer, a solution associated with the query from at least one of a second user device or one or more sources, wherein the second user device is associated with a second user of the set of users; and
rendering, by the computer, the solution on the first user device.

8. The computer-implemented method of claim 7, further comprising:
retrieving, by the computer, second input data comprising a second set of attributes associated with the second user, wherein the second user is associated with the first user;
applying, by the computer, the second ML model on the second input data;
classifying, by the computer, the second user into the set of categories based on the application of the second ML model on the second input data; and
generating, by the computer, a second user profile based on the second input data and the set of categories, wherein the second user profile is associated with the second user.

9. The computer-implemented method of claim 8, further comprising:
identifying, by the computer, an association of the second user profile with the query based on the reception of the query;
rendering, by the computer, the query on the second user device based on the identification of the association of the second user profile with the query;
obtaining, by the computer, the solution from the second user device based on the rendering of the query on the second user device; and
rendering, by the computer, the obtained solution on the first user device.

10. The computer-implemented method of claim 1, further comprising:
receiving, by the computer, feedback associated with the determination of the segment of the media content; and
training, by the computer, the first ML model based on the received feedback.

11. The computer-implemented method of claim 1, wherein the media content is in at least one of an audio format, a video format, or a textual format.

12. The computer-implemented method of claim 1, further comprising:
applying, by the computer, a speech recognition process on the media content;
determining, by the computer, a first set of parameters based on the application of the speech recognition process, wherein the first set of parameters corresponds to textual data associated with the media content;
storing, by the computer, the first set of parameters associated with the media content, wherein the first set of parameters is stored in a sequence of occurrence during the event;
applying, by the computer, the first ML model on the first set of parameters and the first input data; and
determining, by the computer, the segment of the media content based on the application of the first ML model on the first set of parameters and the first input data.

13. The computer-implemented method of claim 1, further comprising:
applying, by the computer, at least one of an optical character recognition process or a neural net ingestion process on the media content;
determining, by the computer, a second set of parameters based on the application of at least one of the optical character recognition process or the neural net ingestion process, wherein the second set of parameters corresponds to at least one of textual data associated with the media content, audio data associated with the media content, or video data associated with the media content;
storing, by the computer, the second set of parameters associated with the media content, wherein the second set of parameters is stored in a sequence of occurrence during the event;
applying, by the computer, the first ML model on the second set of parameters and the first input data; and
determining, by the computer, the segment of the media content based on the application of the first ML model on the second set of parameters and the first input data.

14. The computer-implemented method of claim 1, wherein the first set of attributes comprises at least one of activity data associated with the first user, assignment data associated with the first user, social media data associated with the first user, historical contribution data associated with the first user, expertise area data associated with the first user, field-of-interest data associated with the first user, behavior data associated with the first user, work pattern data associated with the first user, or feedback data associated with the first user.

15. The computer-implemented method of claim 1, further comprising:
monitoring, by the computer, an interaction of the first user with the segment of the media content;
calculating, by the computer, a completion score of the segment based on the monitoring of the interaction, wherein the completion score is indicative of completion of the interaction of the first user with the segment; and
rendering, by the computer, the completion score on the first user device.

16. A computer system, comprising:
a processor set;
one or more computer-readable storage media; and
program instructions stored on the one or more computer-readable storage media, the program instructions executable by the processor set to cause the processor set to:
retrieve media content associated with an event;
retrieve first input data that comprises a first set of attributes associated with a first user of a set of users, wherein the first user is one of an active participant of the event or a passive participant of the event;
apply a first machine learning (ML) model on the media content and the first input data;
generate a similarity score between the media content and the first input data based on the application of the first ML model on the media content and the first input data;
determine the similarity score is greater than a threshold score;
determine a segment of the media content based on the determination that the similarity score is greater than the threshold score, wherein the segment is correlated with the first set of attributes; and
render at least one of an alert or the segment on a first user device associated with the first user, wherein the alert is associated with the segment.

17. The computer system of claim 16, wherein the program instructions further cause the processor set to:
retrieve engagement data associated with the first user and the event, wherein the engagement data is indicative of an active participation of the first user in the event;
identify a presence of an ongoing association of the first user with the event based on the retrieval of the engagement data;
determine the first user corresponds to the active participant of the event based on the identification of the presence of the ongoing association;
generate the alert to notify the first user, wherein the alert is generated based on the determination that the first user corresponds to the active participant of the event and the determination of the segment; and
render the generated alert on the first user device.

18. The computer system of claim 16, wherein the program instructions further cause the processor set to:
retrieve engagement data associated with the first user and the event, wherein the engagement data is indicative of a passive participation of the first user in the event;
identify an absence of an ongoing association of the first user with the event based on the retrieval of the engagement data;
determine the first user corresponds to the passive participant of the event based on the identification of the absence of the ongoing association and the determination of the segment; and
render the segment on the first user device based on the determination that the first user corresponds to the passive participant of the event.

19. The computer system of claim 16, wherein the program instructions further cause the processor set to:
receive feedback associated with the determination of the segment of the media content; and
train the first ML model based on the received feedback.

20. A computer-program product for determination of a segment of media content, the computer-program product comprising:
one or more computer-readable storage media; and
program instructions stored on the one or more computer-readable storage media to perform operations comprising:
retrieving the media content associated with an event;
retrieving first input data comprising a first set of attributes associated with a first user of a set of users, wherein the first user is one of an active participant of the event or a passive participant of the event;
applying a first machine learning (ML) model on the media content and the first input data;
determining the segment of the media content based on the application of the first ML model on the media content and the first input data, wherein the segment is correlated with the first set of attributes; and
rendering at least one of an alert or the segment on a first user device associated with the first user, wherein the alert is associated with the segment.
